(19) United States
(12) Patent Application Publication
(10) Pub. No.: US 2014/0153180 A1
(43) Pub. Date: Jun. 5, 2014

(54) EXPANSION CARD MODULE

(71) Applicants: HONG FU JIN PRECISION INDUSTRY (ShenZhen) CO., LTD., (US); HON HAI PRECISION INDUSTRY CO., LTD., New Taipei (TW)

(72) Inventor: JUN-HUI WANG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/725,935

(22) Filed: Dec. 21, 2012

(30) Foreign Application Priority Data
Dec. 4, 2012 (CN) 201210510714.8

(51) Int. Cl. G06F 1/16

(52) U.S. Cl. CPC G06F 1/16
USPC 361/679.32

(57) ABSTRACT

An expansion card module includes a bracket, a connection circuit board with a socket, and an expansion card. The bracket includes a bottom wall and a sidewall extending from a side of the bottom wall. The connection circuit board is mounted to the bottom wall. The expansion card includes a blocking piece attached to a first side of the expansion card. The expansion card is inserted in the socket. The blocking piece is positioned to the sidewall. A clipping member is set on the bottom wall away from the sidewall, for clipping onto a second side of the expansion card opposite to the first side.

### BACKGROUND

1. Technical Field

The disclosure relates to an expansion card module.

2. Description of Related Art

Computer systems include expansion cards to expand the capability of the computer systems. Conventionally, expansion cards are mounted to expansion slots of the computer systems, but are easily damaged when the computer system receive a shock or impact.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an exemplary embodiment of an expansion card module.

FIG. 2 is similar to FIG. 1, but viewed from another aspect.

FIG. 3 and FIG. 4 show two different assembly states of the expansion card module of FIG. 2.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean “at least one.”

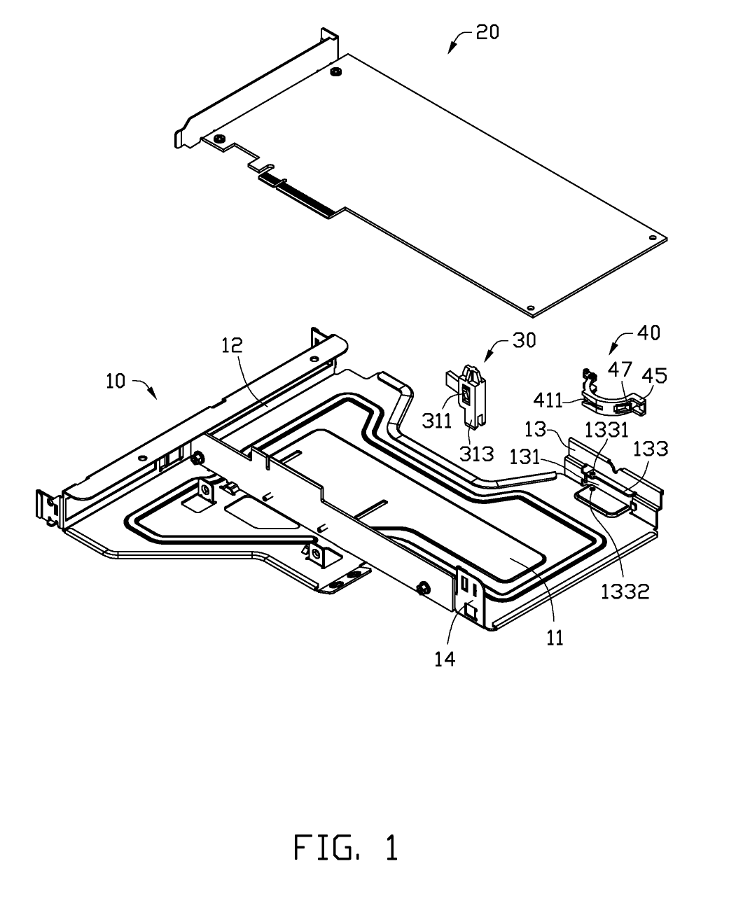

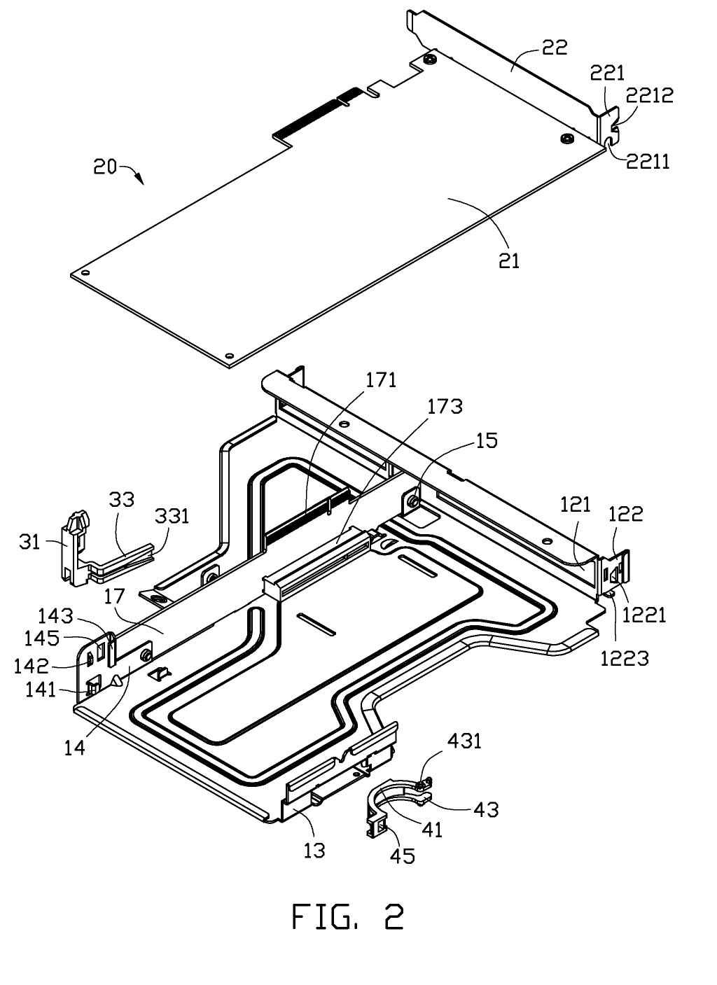

Referring to FIG. 1 and FIG. 2, an exemplary embodiment of an expansion card module includes a bracket 10, an expansion card 20, a locking member 30, and a clipping member 40.

The bracket 10 includes a bottom wall 11, a sidewall 12 perpendicularly extending up from a first side of the bottom wall 11, and a first mounting piece 13 and a second mounting piece 14 perpendicularly extending up from opposite ends of a second side of the bottom wall 11. The first mounting piece 13 and the second mounting piece 14 are parallel to each other and perpendicular to the sidewall 12. A tab 15 extends up from the bottom wall 11 adjacent to the sidewall 12, and is aligned with the second mounting piece 14. A connection circuit board 17 is set on the bottom wall 11, with one end of the connection circuit board 17 fixed to the second mounting piece 14 and the other end to the tab 15. The connection circuit board 17 is perpendicular to the bottom wall 11, and includes a plugging portion 171 extending up from a side of the connection circuit board 17 opposite to the bottom wall 11, and a socket 173 arranged on a side surface of the connection circuit board 17 facing the first mounting piece 13.

An opening 121 is defined in a middle portion of the sidewall 12. A supporting piece 122 extends out from one end of the sidewall 12. A substantially trapezoidal hole 1221 is defined in a middle portion of the supporting piece 122. A raised portion 1223 extends straight out from a bottom of the supporting piece 122.

The first mounting piece 13 defines a through slot 131 in a middle portion, and forms a holding piece 133 extending inward from an inner surface of the first mounting piece 13 above the through slot 131. A through hole 1331 is defined in one end of the holding piece 133. A through hole 1332 is defined in the bottom wall 11 and aligned with the through hole 1331.

An L-shaped fixing portion 141 extends inward from a lower portion of the second mounting piece 14. A raised bridge 142 and an L-shaped retaining portion 143 extend inward from an upper portion of the second mounting piece 14 above the fixing portion 141. A fixing hole 145 is defined in the second mounting piece 14, between the raised bridge 142 and the retaining portion 143.

The expansion card 20 includes a circuit board 21 and a blocking piece 22 fixed on a first end of the circuit board 21. A bent piece 221 perpendicularly extends outward from one end of the blocking piece 22. A cutout 2211 is defined in a bottom of the bent piece 221. The bent piece 221 further defines a cutout in a side edge and forms two protrusions 2212 bounding the cutout.

The locking member 30 includes a main body 31, a resilient portion 311 extending from a first side of the main body 31, an engaging portion 313 extending from a bottom of the main body 31 along the first side of the main body 31, and a substantially L-shaped positioning portion 33 extending from a bottom of a second side of the main body 31 opposite to the resilient portion 311. A horizontal positioning slot 331 is defined in a side of the positioning portion 33, opposite to the main body 31.

The clipping member 40 includes a substantially C-shaped pressing portion 41, a pivoting portion 43 formed at a first end of the pressing portion 41, an operation portion 45 formed at a second end of the pressing portion 41, and a wedge shaped clipping portion 47 formed on an outer surface of the pressing portion 41 adjacent to the operation portion 45. A clipping slot 411 is defined in a middle portion of the outer surface of the pressing portion 41. Two pins 431 are exposed from opposite sides of the pivoting portion 43.

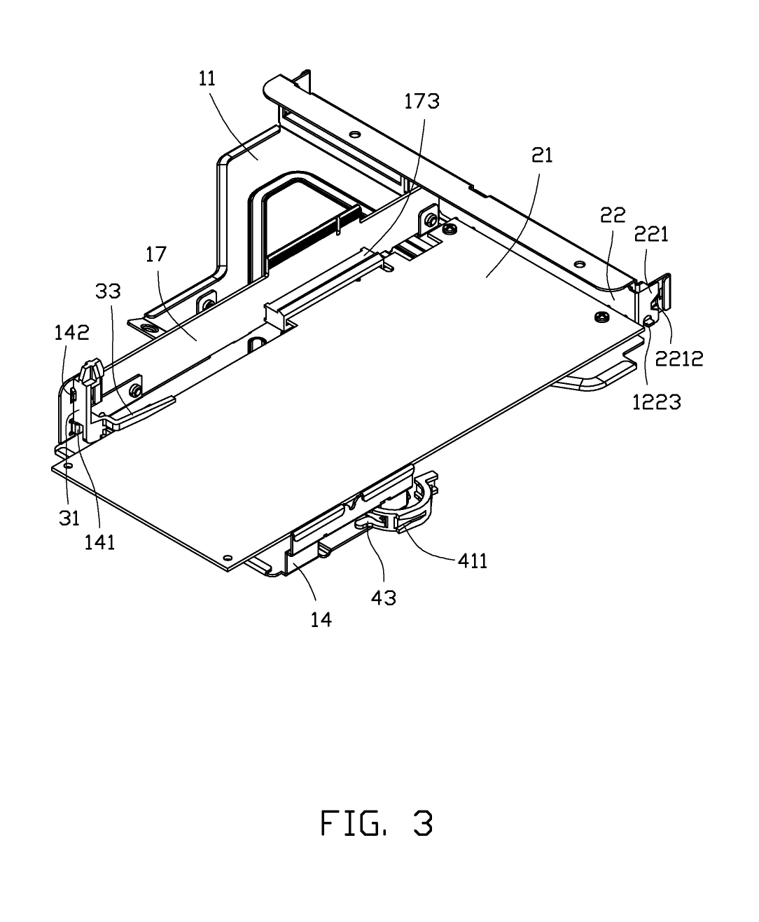

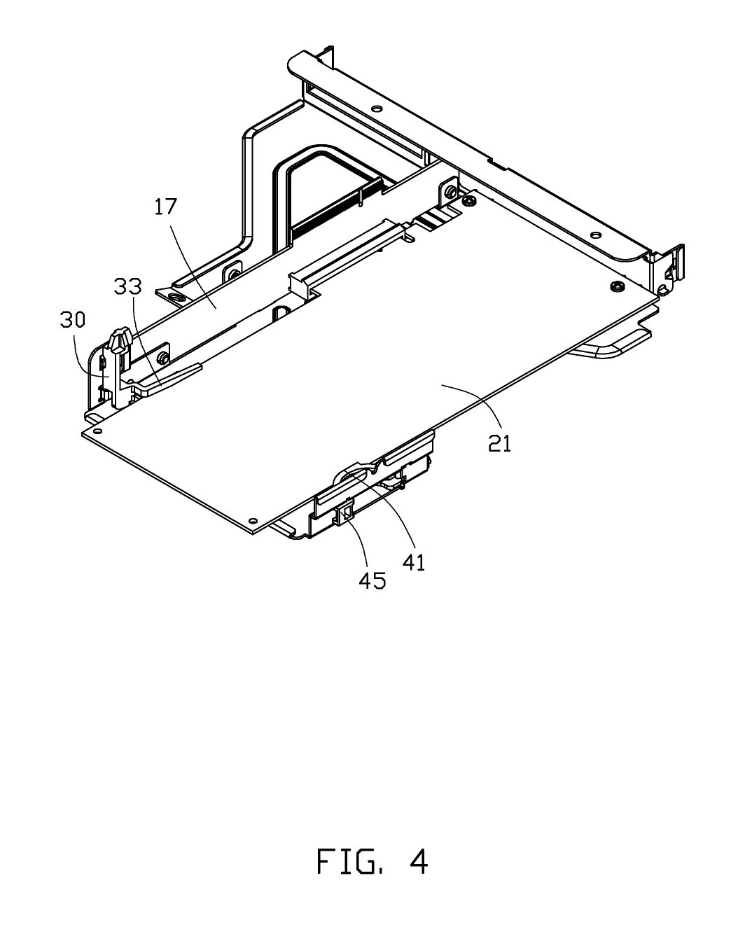

Referring to FIGS. 3 and 4, in assembly, the main body 31 of the locking member 30 is located between the raised bridge 142 and the retaining portion 143, and is in tight contact with the second mounting piece 14. The main body 31 is pressed down until the engaging portion 313 engages in the fixing portion 141, and the resilient portion 311 restores to engage in the fixing hole 145. Thus, the locking member 30 is fixed to the second mounting piece 14. The pins 431 pivotably engage in the through holes 1331 and 1332, thus the clipping member 40 is pivotably connected to the first mounting piece 13. The pressing portion 41 is rotatable, and in rotating, extends through the through slot 131.

The circuit board 21 is plugged into the socket 173, with the circuit board 21 parallel to the bottom wall 11. The blocking piece 22 shields the opening 1221. The bent piece 221 contacts the supporting piece 122. The raised portion 1223 engages in the cutout 2211. The protrusions 2212 engage in the hole 1221.

A first side of a second end of the circuit board 21 opposite to the blocking piece 22 engages in the positioning slot 331. The operation portion 45 is operated to rotate the clipping member 40, until the clipping portion 47 extends through the through slot 131, to be blocked by a part of an inner surface of the first mounting piece 13 adjacent to the through slot 131. A second side of the second end of the circuit board 21 is limited in the clipping slot 411. Therefore, the second end of the circuit board 21 is retained between the locking member 30 and the clipping member 40. The plugging portion 171 of the connection circuit board 17 can be plugged into a motherboard (not shown).

It is to be understood, however, that even though numerous characteristics and advantages of certain embodiments have been set forth in the foregoing description, together with details of the structures and functions of the embodiments, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. An expansion card module, comprising:
a bracket comprising a bottom wall and a sidewall extending up from a first side of the bottom wall;
a connection circuit board perpendicularly fixed on the bottom wall, the connection circuit board comprising a socket;
an expansion card comprising a circuit board plugged in the socket of the connection circuit board and a blocking piece fixed on a first end of the circuit board, wherein the blocking piece is positioned at the sidewall; and
a locking member arranged on a second side of the bottom wall opposite to the sidewall, wherein the locking member retains a second end of the circuit board opposite to the blocking piece.

2. The expansion card module of claim 1, further comprising a clipping member, wherein the locking member and the clipping member retain two opposite sides of the second end of the circuit board.

3. The expansion card module of claim 2, wherein a first mounting piece and a second mounting piece extend on the second side of the bottom wall and parallel to each other, the locking member is fixed to the second mounting piece, the clipping member is pivotably connected to the first mounting piece.

4. The expansion card module of claim 3, wherein the first mounting piece defines a through slot in a middle portion and forms a holding piece extending inward from an inner surface of the first mounting piece above the through slot, a first through hole is defined in one end of the holding piece, a second through hole is defined in the bottom wall and aligned with the first through hole, a pivoting portion is formed at a first end of the clipping member, two pins extend from opposite sides of the pivoting portion, the pins pivotably engage in the first and second through holes, respectively, to pivotably connect the clipping member to the first mounting piece.

5. The expansion card module of claim 4, wherein the clipping member comprises a C-shaped pressing portion for retaining the circuit board, the pivoting portion is formed at a first end of the pressing portion, an operation portion is formed at a second end of the pressing portion, a wedge shaped clipping portion is formed on an outer surface of the pressing portion adjacent to the operation portion, the clipping portion extends through the through slot of the first mounting piece to be blocked by a part of an inner surface of the first mounting piece adjacent to the through slot.

6. The expansion card module of claim 5, wherein a clipping slot is defined in a middle portion of the outer surface of the pressing portion, for receiving an edge of the circuit board.

7. The expansion card module of claim 3, wherein the locking member comprises a main body fixed to the second mounting piece and a positioning portion extending from a bottom of the main body, a horizontal positioning slot is defined in a side of the positioning portion, for receiving an edge of the circuit board.

8. The expansion card module of claim 7, wherein a resilient portion extends from a first side of the main body, an engaging portion extends from a bottom of the main body along the first side of the main body, an L-shaped fixing portion extends inward from a lower portion of the second mounting piece, a raised bridge and an L-shaped retaining portion extend inward from an upper portion of the second mounting piece above the fixing portion, a fixing hole is defined in the second mounting piece between the raised bridge and the retaining portion, the main body of the locking member is located between the raised bridge and the retaining portion and in tight contact with the second mounting piece, the engaging portion engages in the fixing portion, and the resilient portion engages in the fixing hole.

9. The expansion card module of claim 1, wherein an opening is defined in a middle portion of the sidewall, a supporting piece extends outward from one end of the sidewall, a hole is defined in a middle portion of the supporting piece, a raised portion extends on a bottom of the supporting piece, a bent piece extends outward from one end of the blocking piece, a cutout is defined in a bottom of the bent piece, the bent piece forms two protrusions, the blocking piece shields the opening of the sidewall, the bent piece contacts with the supporting piece, the raised portion engages in the cutout, the protrusions engage in the hole of the supporting piece.

10. The expansion card module of claim 1, wherein the expansion card is parallel to the bottom wall.

11. An expansion card module, comprising:
a bracket comprising a bottom wall, a sidewall extending up from a first side of the bottom wall, and a first mounting piece extending up from a second side of the bottom wall opposite to the sidewall;
a connection circuit board perpendicularly fixed on the bottom wall, the connection circuit board comprising a socket;
an expansion card comprising a circuit board plugged in the socket of the connection circuit board and a blocking piece fixed on a first end of the circuit board, wherein the blocking piece is positioned at the sidewall; and
a clipping member pivotably connected to the first mounting piece, wherein the clipping member retains a second end of the circuit board opposite to the blocking piece.

12. The expansion card module of claim 11, wherein the first mounting piece defines a through slot in a middle portion and forms a holding piece extending inward from an inner surface of the first mounting piece above the through slot, a first through hole is defined in one end of the holding piece, a second through hole is defined in the bottom wall and aligned with the first through hole, a pivoting portion is formed at a first end of the clipping member, two pins extend from opposite side of the pivoting portion, the pins pivotably engage in the first and second through holes, respectively, to pivotably connect the clipping member to the first mounting piece.

13. The expansion card module of claim 12, wherein the clipping member comprises a C-shaped pressing portion for retaining the circuit board, the pivoting portion is formed at a first end of the pressing portion, an operation portion is formed at a second end of the pressing portion, a wedge shaped clipping portion is formed on an outer surface of the pressing portion adjacent to the operation portion, the clipping portion extends through the through slot of the first mounting piece to be blocked by a part of an inner surface of the first mounting piece adjacent to the through slot.

14. The expansion card module of claim 13, wherein a clipping slot is defined in a middle portion of the outer surface of the pressing portion, for receiving an edge of the circuit board.

15. The expansion card module of claim 11, further comprising a locking member, wherein the locking member and the clipping member retain two opposite sides of the second end of the circuit board.

16. The expansion card module of claim 15, wherein a second mounting piece extend on the second side of the bottom wall and parallel to the first mounting piece, the locking member is fixed to the second mounting piece.

17. The expansion card module of claim 16, wherein the locking member comprises a main body fixed to the second mounting piece and a positioning portion extending from a bottom of the main body, a horizontal positioning slot is defined in a side of the positioning portion, for receiving an edge of the circuit board.

18. The expansion card module of claim 17, wherein a resilient portion extends from a first side of the main body, an engaging portion extends from a bottom of the main body along the first side of the main body, an L-shaped fixing portion extends inward from a lower portion of the second mounting piece, a raised bridge and an L-shaped retaining portion extend inward from an upper portion of the second mounting piece above the fixing portion, a fixing hole is defined in the second mounting piece between the raised bridge and the retaining portion, the main body of the locking member is located between the raised bridge and the retaining portion and in tight contacts with the second mounting piece, the engaging portion engages in the fixing portion, and the resilient portion engages in the fixing hole.

19. The expansion card module of claim 11, wherein an opening is defined in a middle portion of the sidewall, a supporting piece extends outward from one end of the sidewall, a hole is defined in a middle portion of the supporting piece, a raised portion extends on a bottom of the supporting piece, a bent piece extends outward from one end of the blocking piece, a cutout is defined in a bottom of the bent piece, the bent piece forms two protrusions, the blocking piece shield the opening of the sidewall, the bent piece contacts with the supporting piece, the raised portion engages in the cutout, the protrusions engage in the hole of the supporting piece.

20. The expansion card module of claim 11, wherein the expansion card is parallel to the bottom wall.
